(19) United States
(12) Patent Application Publication
(10) Pub. No.: US 2012/0076356 A1
(43) Pub. Date: Mar. 29, 2012

(54) ANOMALY DETECTION APPARATUS

(75) Inventors: Yuan LI, Hitachi (JP); Masanori Miyoshi, Mito (JP); Masaya Itoh, Hitachinaka (JP); Ryou Yumiba, Tokai (JP)

(73) Assignee: HITACHI, LTD.

(21) Appl. No.: 13/213,202

(22) Filed: Aug. 19, 2011

(30) Foreign Application Priority Data
Sep. 27, 2010 (JP) 2010-214663

(51) Int. Cl. G06K 9/00

(52) U.S. Cl. 382/103

(57) ABSTRACT

Behavior authority may be changed depending on a behavior performed by a person. Therefore, it is necessary to change the judgment criteria whether the behavior is anomalous or normal, in association with the changed behavior authority. Herein, an anomaly detection apparatus is provided, which calculates the behavior authority information of which judgment criteria of the anomalous and normal behaviors are changed corresponding to the behavior performed by the person, detects whether the behavior shown by the person is anomalous or not, and issues an alarm when the anomalous behavior is detected.

### CROSS REFERENCE TO RELATED APPLICATIONS

This application claims the foreign priority benefit under Title 35, United State Code, 119(a)-(d) of Japanese Patent Application No. 2010-214663, filed on Sep. 27, 2010 in the Japan Patent Office, the disclosure of which is herein incorporated by reference in its entirety.

### BACKGROUND OF THE INVENTION

1. Field of the Invention

The present invention relates to an apparatus of detecting an anomalous behavior of a person who is monitored by an authentication apparatus and a monitoring apparatus.

2. Description of the Related Art

Conventionally, a lot of methods for detecting an illegal behavior or a prohibited behavior of a person have been proposed, depending on the authority of behavior corresponding to the authentication information.

As a specific technique for realizing the above mentioned method, for example, International Patent Publication No. WO2007/138811 discloses a method for detecting anomaly. The method comprises the steps of determining authority of behavior of a person by authentication information such as color data and a face image, and determining the behavior of the person as anomalous when the behavior exceeds the authority of behavior. Namely, the technique analyzes in detail the behavior of the monitoring person, and allows no alarm to be issued when the behavior of the person is within the authority of behavior authorized to the person, while the technique allows an alarm to be issued when the behavior of the person exceeds the authority of behavior.

In the meantime, the Japanese Laid-Open Patent Publication No. 2006-65719 discloses a method for detecting an anomalous behavior and situation, by recognizing a specific pattern of the behavior or situation. For example, if a door is closed and opened three times in total within a releasable time, a security system releases an alarm mode deciding that the actions are done in the same way as the specific pattern, while if a door is closed and opened three times and more within a releasable time, the security system decides that it is an anomalous situation and issues an alarm because the actions are not done in the same way as the specific pattern.

However, in the case of regular monitoring, the authority of behavior may be changed by the behavior performed by a person. Accordingly, in accordance with the changed authority of behavior, it is needed to change the judgment criteria of normality and anomaly. For example, in the case of a store, if a customer takes goods, the customer can not exit from the store without paying for the goods. The customer has to pay for the goods. Usually, it is a normal behavior for a customer to exit from the store. However, if the activity of a customer to take goods occurs, the authority of behavior of the customer is changed and the activity of exiting from the store without paying money becomes an anomalous behavior. Therefore, in accordance with the changed authority of behavior, it is needed to change the judgment criteria of normality and anomaly.

According to the International Patent publication No. WO2007/138811, the behavior performed by a person is not reflected to the decision whether the behavior is normal or anomalous, resulting in a drawback that the method of the above mentioned patent document can not decide whether the behavior is normal or anomalous. For example, assuming the case of a store, a customer takes a variety of normal behaviors including: entering a store, exiting from a store, taking goods, and buying the goods. However, by the aforementioned method it is needed to decide that the behavior of the customer is anomalous, if the customer takes goods and exits from the store without buying the goods.

According to the Japanese Laid-Open Patent Publication No. 2006-65719, assuming the same example as mentioned above, by using the method of the patent document, the security system may issue no alarm, if behaviors of a customer of taking goods, buying the goods and exiting from a store are recognized as a series of patterns In contrast, if the behaviors are classified in neither of the specific patterns, the security system may decide that it is an anomalous incident or an anomalous behavior, and issue an alarm. However, in the aforementioned technique, the patterns that may be decided as anomalous or not are limited to the specific patterns determined in advance, and may not be applied to various behaviors of a person. Accordingly, the technique has a drawback that behaviors performed by a person may not be reflected to the change in decision criteria whether the behaviors performed by the person are normal or anomalous.

### SUMMARY OF THE INVENTION

The present invention has been developed in order to solve the above mentioned conventional drawbacks. Therefore, an object of the present invention is to realize an anomaly detection apparatus capable of determining whether a behavior performed by a person is anomalous or not in association with the situation, through modifying the authority of behavior by the behavior of the person.

Note that other objects besides the aforementioned object will be clarified referring to the descriptions of the entire present specification or drawings.

The anomaly detection apparatus is an apparatus of detecting an anomalous behavior of a person, by cooperating with an image information input section that outputs a moving image as image information by taking a picture of a person with using a camera and an authentication information input section that outputs authentication information of the person by authenticating the person. The anomaly detection apparatus comprises: a behavior recognition section that detects a person included in the moving image resulting from the image information input section, recognizes the behavior of the person, and extracts the behavior of the person thereby to output behavior information of the person; and a behavior authority list that defines anomalous and normal behaviors in advance, corresponding to the authentication information resulting from the authentication information input section.

The anomaly detection apparatus further comprises: a behavior authority determination section that refers to the behavior authority list corresponding to the authentication information of the person, inputted from the authentication information input section, obtains information of the anomalous and normal behaviors performed by the person, and outputs the information as a behavior authority information list; and a behavior authority management section that calculates the behavior authority of the person corresponding to the behavior of the person, based on the behavior information of the person, inputted from the behavior recognition section, and the behavior authority information list inputted from the behavior authority determination section, and outputs behavior authority information of the person.

The anomaly detection apparatus further comprises: an anomaly behavior judgment section that refers to the behavior authority information inputted from the behavior authority management section, determines whether the behavior of the person, shown by the behavior of the person information inputted from the behavior recognition section, is anomalous or not, and outputs alarm information if the behavior is determined as anomalous; and an output section that issues an alarm when the alarm information is inputted from the anomaly behavior judgment section.

Note that the aforementioned construction is only an example, and various modifications may be performed without apart from the scope and technical ideas of the present invention. Further, embodiments of construction of the present invention besides the aforementioned construction will be clarified referring to the descriptions of the entire present specification or drawings.

The anomaly detection apparatus of the present invention may change judgment criteria whether a behavior performed by a person is normal or anomalous depending on the behavior of the person. Other effects of the present invention will be clarified by the descriptions of the entire present specification.

### BRIEF DESCRIPTION OF THE DRAWINGS

FIG. 1 is a diagram showing a function and construction of the entire anomaly detection apparatus in an embodiment of the present invention.

FIG. 2 is a schematic diagram showing an inside construction of the behavior authority management section of the anomaly detection apparatus.

FIG. 3 is a schematic diagram showing a data flow of the anomaly detection apparatus in an embodiment of the present invention.

FIG. 4 is a behavior authority list in an embodiment of the present invention.

FIG. 5 is a flow chart of the anomaly detection apparatus in an embodiment of the present invention.

FIG. 6 is a diagram showing a function and construction of the entire anomaly detection apparatus in an embodiment of the present invention.

FIG. 7 is an exemplary diagram showing an anomaly operation detection apparatus in an embodiment of the anomaly detection apparatus.

FIG. 8 is an exemplary diagram showing an anomaly detection apparatus used for a store in an embodiment of the anomaly detection apparatus.

FIG. 9 is an exemplary diagram showing an anomaly detection apparatus of illegal entry in an embodiment of the anomaly detection apparatus.

FIG. 10 is an exemplary diagram showing an evacuation guidance apparatus in an embodiment of the anomaly detection apparatus.

FIG. 11 is an exemplary diagram showing a boarding announcement apparatus in an airport in an embodiment of the anomaly detection apparatus.

### DETAILED DESCRIPTION OF THE PREFERRED EMBODIMENT

Next, an embodiment of the present invention will be explained referring to drawings. Note that in the respective drawings and embodiments, the same or similar component will be referred to as the same reference number, and the explanation thereof will be omitted.

According to the present invention, the anomaly detection apparatus capable of judging whether anomaly occurs or not corresponding to a situation by modifying the authority of behavior in association with the behavior performed by a person has been realized.

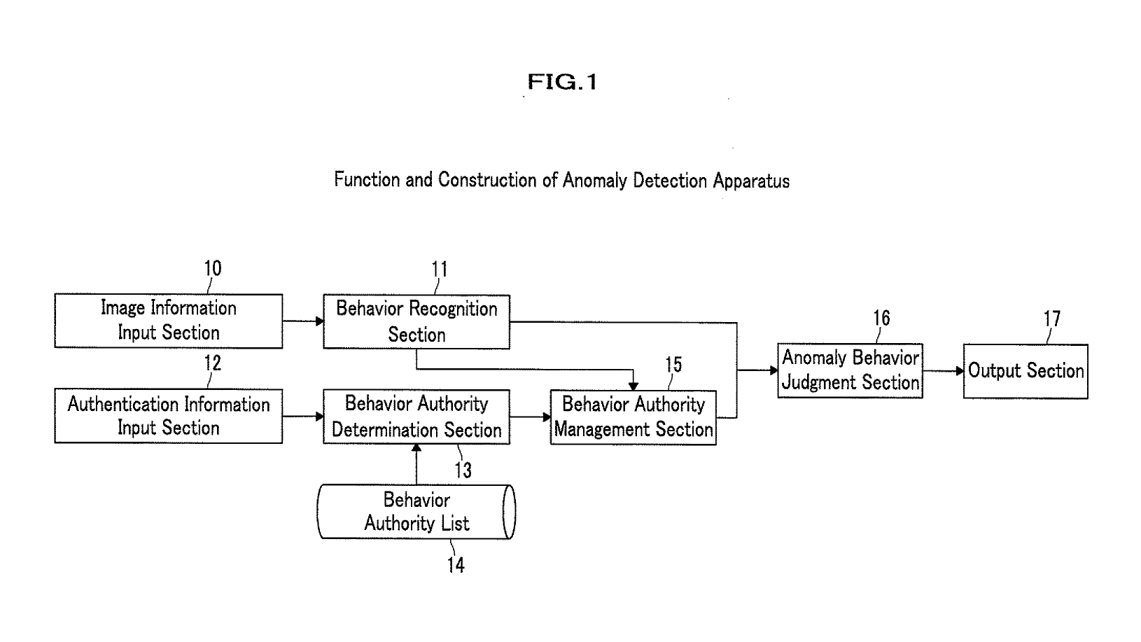

FIG. 1 is a diagram showing the function and construction of the entire anomaly detection apparatus in an embodiment of the present invention. As shown in FIG. 1, the present embodiment of the anomaly detection apparatus comprises an image information input section 10, a behavior recognition section 11, an authentication information input section 12, a behavior authority determination section 13, a behavior authority list 14, a behavior authority management section 15, an anomaly behavior judgment section 16, and an output section 17.

The image information input section 10 is a moving image device such as a video camera, which acquires image data taken and outputs the moving image data as image information to the behavior recognition section 11.

The behavior recognition section 11 detects a person included in the image data inputted from the image information input section 10, recognizes the behavior of the person, extracts the behavior information of the person, and outputs the behavior information of the person to the behavior authority management section 15 and the anomaly behavior judgment section 16.

The authentication information input section 12 outputs the authentication information including an ID, a certification number, a face image, and a fingerprint image or the like of the person, which can certify the person by, for example, a password, a monitoring camera, a vain, a face, a finger print, a pupil, an IC card and a mobile phone or the like, to the behavior authority determination section 13.

The behavior authority determination section 13 accesses the behavior authority list 14 in order to obtain the behavior authority information corresponding to the authentication information of the person, inputted from the authentication information input section 12. Then, the behavior authority determination section 13 obtains normal and anomalous behaviors, or permitted and prohibited behaviors corresponding to the person, based on the behavior authority list 14, and outputs the behavior authority information list to the behavior authority management section 15.

The behavior authority list 14 is a list predetermined in advance that defines a normal behavior and an anomalous behavior, or a permitted behavior and a prohibited behavior, in association with each person (or authentication information of the person).

The behavior authority management section 15 calculates the behavior authority of the person (or behavior authority after modified by the person) corresponding to the behavior performed by the person, by referring to the behavior information of the person, inputted from the behavior recognition section 11, and to the behavior authority information list of the person, inputted from the behavior authority determination section 13. Then, the behavior authority management section 15 outputs the behavior authority information of the person to the anomaly behavior judgment section 16.

The anomaly behavior judgment section 16 refers to the behavior authority information of the person, inputted from the behavior authority management section 15, and judges whether the behavior of the person which is shown by the behavior information inputted from the behavior recognition section 11 is a normal behavior or an anomalous behavior. Then, the anomaly behavior judgment section 16 outputs the alarm information to the output section 17, if the anomaly behavior judgment section 16 detects an anomalous behavior and a prohibited behavior.

The output section 17 issues an alarm when the alarm information is inputted from the anomaly behavior judgment section 16.

Note that the behavior recognition section 11 detects a person from images and pictures, recognizes the detected behavior of the person, and creates the behavior information. Herein, the recognized behavior of the person has various types depending on the monitoring areas. For example, in the case of a store, such a behavior includes behaviors of taking goods, looking at goods, paying money, and exiting from the store. In the case of a production line of a factory, by regarding location information as a behavior, the behavior information may be created. Further, by regarding a state of a person such as a color of a working wear or an appearance of the person as a behavior, the behavior information of the person may be created. The definition of the “behavior” in other sections such as the behavior authority list 14 is not limited to the behavior in the narrow sense, and may include a location and a state of the person.

A method described in, for example, “A System for Video Surveillance and Monitoring” tech. report CMU-RI-TR-00-12, Robotics Institute, Carnegie Mellon University, May, 2000, may be used for the detection algorism of the person, the recognition algorism of the person, and the algorism for calculating the location of the person and chasing the person, used in the behavior recognition section 11. Further, by using a sensor, the behavior information that regards the information showing the state of a location, vibration and light as a behavior may be created.

The authentication information input section 12 may cooperate with an entry/exit management apparatus (or access control apparatus) for office security. Note that if the authentication information input section 12 performs anomalous behavior detection for the same person, the authentication information input section 12 may create the authentication information only at the first time, and output the authentication information to the behavior authority determination section 13. Alternatively, the authentication information input section 12 may create the authentication information every time when the entry/exit activity is detected.

The behavior authority determination section 13 may acquire a behavior authority information list of a person in real-time through the behavior authority list 14. When authentication information of a person is inputted by the authentication information input section 12, the behavior authority determination section 13 accesses the behavior authority list 14, and creates the behavior authority information list. Note that when the detection of the anomalous behavior of the same person is performed, the behavior authority determination section 13 may access the behavior authority list 14 only at the first time, and acquire the normal and anomalous behavior information, thereby to create the behavior authority information list.

The behavior authority list 14 may dynamically modify the definition of the normal and anomalous behaviors. For example, the behavior authority list 14 may modify the definition of the normal and anomalous behaviors corresponding to a monitoring area and a time zone. For example, when it becomes a predetermined time or a person enters a predetermined monitoring area, the behavior authority list 14 may modify the definition.

When the behavior authority list 14 modifies the definition, the behavior authority list 14 automatically notifies the modification to the behavior authority determination section 13, and updates the behavior authority information list. Further, the behavior authority list 14 may define behavior authority for a group of persons having the same authentication information. For example, the behavior authority list 14 may regard workers wearing the same working clothes as a group of persons having the same authentication authority, and may detect the anomalous behavior of the group.

The output section 17 issues an alarm when an anomalous behavior is detected, and may use alarming methods utilizing a traditional color, sound, light or the like. The output section 17 may distribute the alarm to a mobile phone or e-mail, and transfer the real image of a person whose behavior is detected as anomalous. Further, the output section 17 may modify output methods corresponding to the definition of the anomalous behavior or the degree of urgency.

Further, the output section 17 may cooperate with other devices, for example, enabling to open and close a door, and control anomaly prevention of a control device. Moreover, the output section 17 may output an alarm of an anomalous behavior or an announcement for performing a normal behavior to a PDA or a mobile terminal.

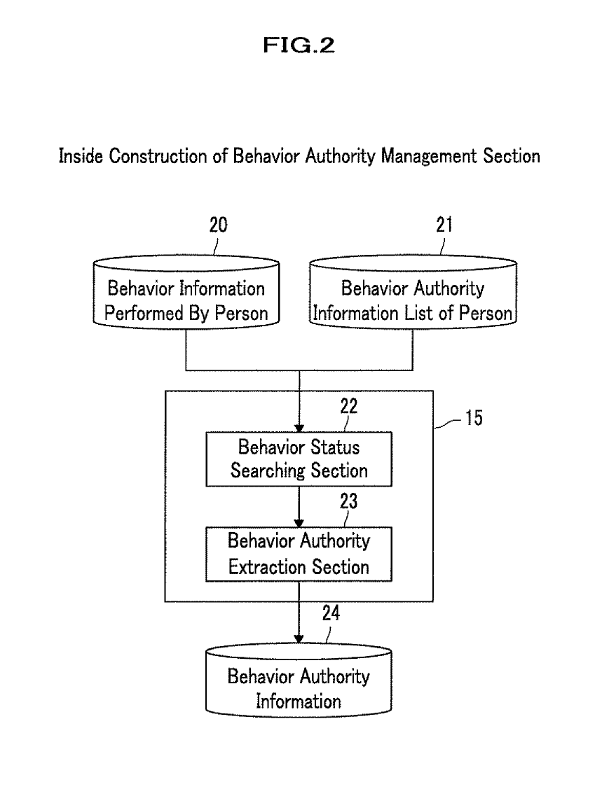

FIG. 2 shows an inside construction of the authority behavior management section in the anomaly detection apparatus in an embodiment of the present invention. The behavior authority management section 15 is composed of a behavior status searching section 22 and a behavior authority extraction section 23.

Behavior information 20 performed by a person, inputted by the behavior recognition section 11 in FIG. 1, and a behavior authority information list 21 of a person, inputted by the behavior authority determination section 13 in FIG. 1, are inputted to the behavior authority management section 15. The behavior status searching section 22 refers to the behavior authority information list 21, searches the behavior performed by the person, and outputs the behavior status information to the behavior authority extraction section 23. Then, the behavior authority extraction section 23 extracts normal and anomalous behaviors of the person, corresponding to the inputted behavior status information, and outputs behavior authority information 24. The behavior authority information 24 is behavior authority modified after the behavior of the person.

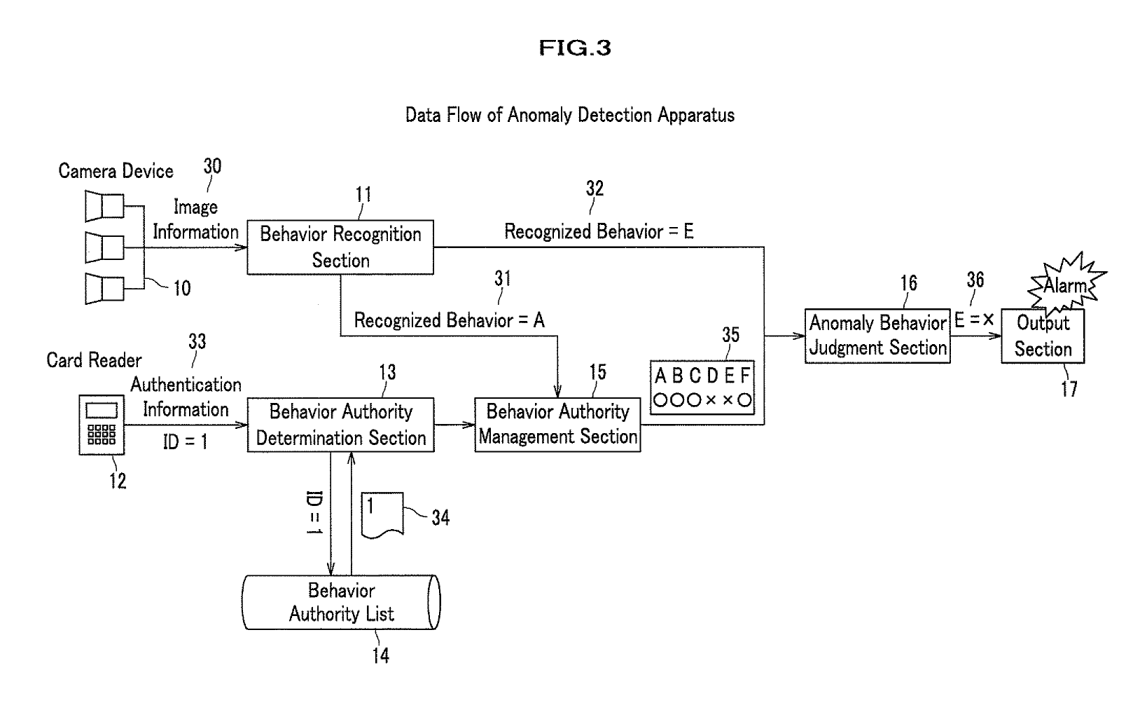

FIG. 3 shows a data flow of the anomaly detection apparatus in an embodiment of the present invention. By using the image information input section 10 such as a camera device, image information 30 including a person is outputted to the behavior recognition section 11. The behavior recognition section 11 recognizes the behavior of the person by the image information 30, and outputs the behavior information 31 to the behavior authority management section 15. For example, if the behavior recognition section 11 recognizes the behavior of the person as “A”, the behavior recognition section 11 outputs “A” to the behavior authority management section 15.

Then, the anomaly detection apparatus reads in a card possessed by a person by using the authentication information input section 12 such as a card reader, and outputs authentication information 33 to the behavior authority determination section 13. For example, if the ID of the person is 1, the authentication information of “ID=1” is outputted. The behavior authority determination section 13 accesses the behavior authority list 14, picks out the definition list of the normal and anomalous behaviors with respect to the information of “ID=1”, and outputs a behavior authority information list 34 to the behavior authority management section 15.

Then, the behavior authority information list 34 and the behavior information 31 of the person are inputted to the behavior authority management section 15. By referring to the behavior authority information list 34, the behavior authority management section 15 extracts behavior authority information 35 corresponding to the behavior resulting from the behavior information 31. For example, when the person performs a behavior of “A”, the behavior authority management section 15 extracts the behavior authority information 35 that classifies normal behaviors in “A”, “B”, “C” and “F”, and anomalous behaviors in “D” and “E”, and outputs the behavior authority information 35 to the anomaly behavior judgment section 16. Herein, the behavior authority information 35 is a behavior authority after the normal behavior and anomalous behaviors were modified corresponding to the behavior resulting from the behavior information 31.

The anomaly behavior judgment section 16 refers to the behavior authority information 35, and determines whether the behavior information of the person 32, inputted from the behavior authentication section 11, is classified in normal or anomalous. For example, if the recognized behavior information is “E”, the behavior authority information 35 indicates that “E” is an anomalous behavior, whereby the anomaly behavior judgment section 16 determines the behavior of “E” as an anomalous behavior. If the behavior is determined as an anomalous behavior, the anomaly behavior judgment section 16 outputs alarm information 36 to the output section 17.

Then, the output section 17 receives the alarm information 36, and issues an alarm.

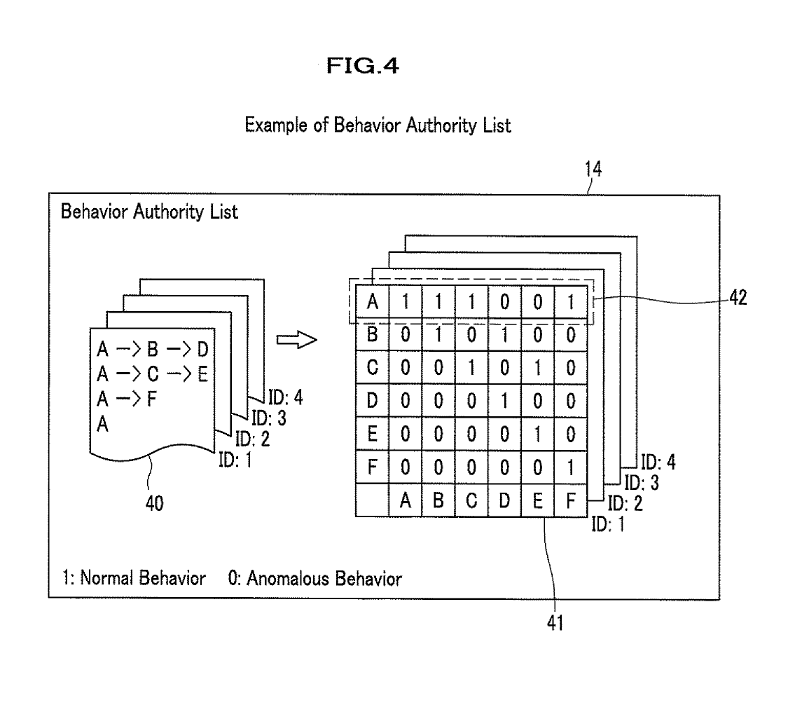

FIG. 4 shows an example of a behavior authority list of the present invention. The behavior authority list 14 defines normal and anomalous behaviors in advance, corresponding to a person (or authentication information of a person). In FIG. 4, the reference No. 40 represents a behavior list that defines the behaviors and the order of the behaviors of the person. For example, the equation of “A→B→D” means that the behaviors of the person are “A”, “B” and “D”. The order of the behaviors of the equation means that the behavior of “B” is conducted after the behavior of “A” was conducted, and then the behavior of “D” is conducted after the behavior of “B” was conducted. The behavior authority list 14 creates a behavior matrix 41 referring to the behavior list 40. The behavior matrix 41 may be created in advance to store the behavior matrix 41 in the behavior authority list, or created by either of the behavior authority determination section 13 and the behavior authority management section 15.

Here, will be explained a case assuming that the behavior matrix 41 is created in advance. In the behavior matrix 41, 1 means a normal behavior and 0 means an anomalous behavior. The most left column and the most bottom line indicate the behaviors of the person. A value in each box defines a normal behavior or an anomalous behavior of the behavior corresponding to the most bottom line after the behavior in the most left column was performed. For example, the behavior authority information 42 in the first line corresponds to the case that the behavior inputted into the behavior authority management section 15 by the behavior recognition section 11 is “A”. Accordingly, the first line of the behavior authority information 42, corresponding to the behavior “A”, defines whether each of the behaviors “A” to “F” in the most bottom line is a normal behavior or an anomalous behavior. In other words, if the person performs the behavior of “A”, the behaviors of the person thereafter of “A”, “B”, “C” and “F” are represented as a value of 1, whereby each of the behaviors is defined as a normal behavior.

Similarly, the behaviors of the person of “D” and “E” are represented as a value of 0, whereby each of the behaviors is defined as an anomalous behavior. If the equation of “A→B→D” represents normal behaviors, values in the corresponding boxes are represented as 1 so that the behaviors are all determined as normal behaviors when the above mentioned behaviors were performed in the order of the equation. For example, since the equation of “A→B” represents normal behaviors, a value of the box corresponding to “A” in the most left column and “B” in the most bottom line is 1. Then, in the equation of “B→D”, a value of the box corresponding to “B” in the most left column and “D” in the most bottom line is 1. Similarly, the behavior matrix 41 may be created by conducting the above mentioned operation for the behaviors in all the behavior lists.

Further, for example, the behavior authority determination section 13 extracts the behavior matrix 41 corresponding to the authentication information 33 (ID=1) by referring to the behavior authority list 14. Then, the behavior authority determination section 13 outputs the behavior authority information list 34 to the behavior authority management section 15. If the behavior information 31 of “A” is inputted, the behavior authority management section 15 outputs the behavior authority information 42 in the first line as the behavior authority information, referring to the behavior matrix 41.

Further, if the authentication information input section 12 can not authenticate a person, the authentication information input section 12 gives the person an ID with the lowest authority. Then, the behavior authority determination section 13 outputs the lowest behavior authority information list predetermined in advance as the behavior authority information list 34, referring to the behavior authority list 14. For example, in the lowest behavior authority information list, values of each behavior box may be set in 0, allowing all the behaviors to be determined as anomalous. The lowest behavior authority information list may be modified corresponding to the time and the monitoring area or the like.

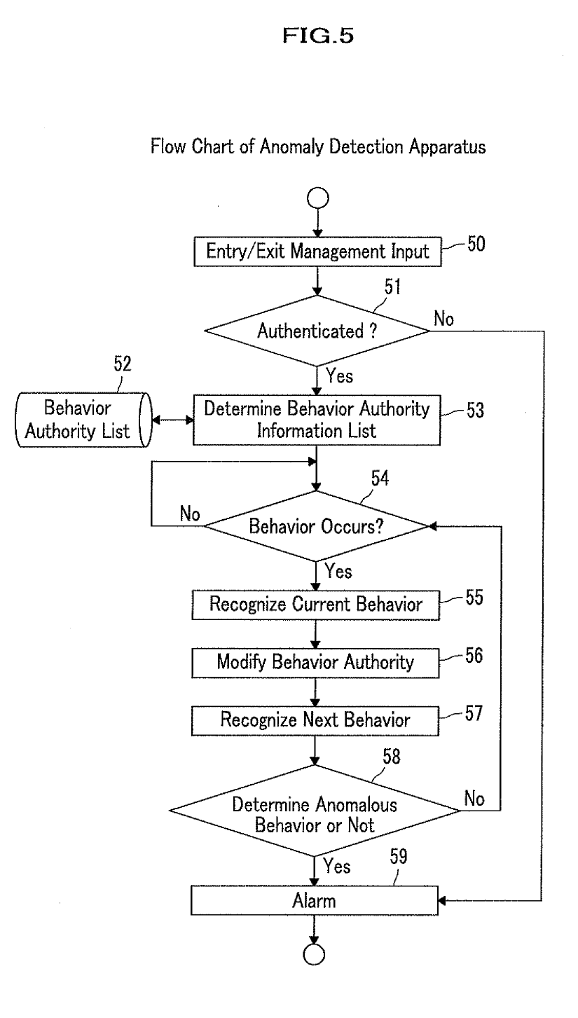

FIG. 5 is a flow chart of the anomaly detection apparatus in an embodiment of the present invention. In the step 50, the authentication information input section 12 reads in a card or the like of a person, and performs an entry/exit management input. In the step 51, the anomaly detection apparatus determines whether the person is to be authenticated or not. If the person is not authenticated, the anomaly detection apparatus determines that the person is a suspicious person and issues an alarm. If the person is authenticated, the anomaly detection apparatus performs the step 53 and the authentication information is inputted into the behavior authority determination section 13.

Then, the anomaly detection apparatus determines the behavior authority information list through the step 52 of referring to the behavior authority list, by the authentication information (for example, ID or the like) of the person. Next, in the step 54, the anomaly detection apparatus determines whether a behavior of the person, which is taken by a camera or the like, exists or not, by using the behavior authority recognition section 11. If a behavior occurs, the anomaly detection apparatus recognizes the behavior in the step 55. In the step 56, based on the resulting behavior, the behavior authority management section 15 modifies the behavior authority, and calculates the behavior authority information. Further, in the step 57, the behavior recognition section 11 recognizes the next behavior of the person who was taken by a camera or the like.

In the step 58, the anomaly behavior judgment section 16 determines whether the behavior recognized in the step 57 is anomalous or not, referring to the calculated behavior authority information. In the step 59, if the anomaly behavior judgment section 16 determines that the behavior is anomalous, the anomaly detection apparatus issues an alarm. If it is determined that no anomalous behavior exists, the anomaly detection apparatus returns to the step 54.

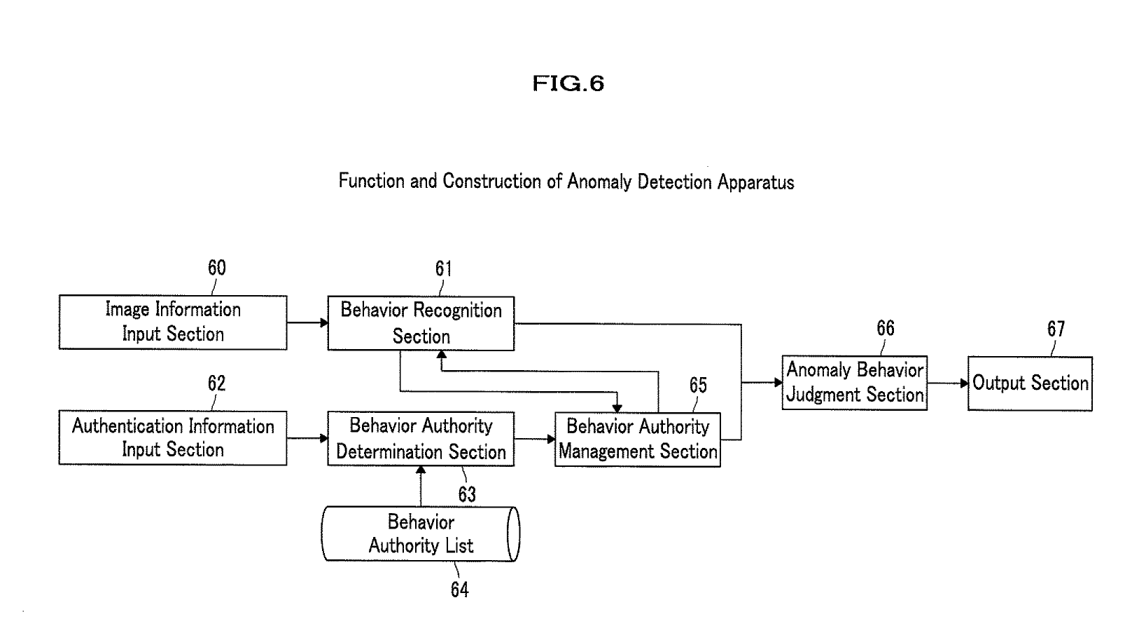

FIG. 6 shows the anomaly detection apparatus in an embodiment of the present invention. In the present embodiment, as shown in FIG. 6, the anomaly detection apparatus comprises an image information input section 60, a behavior recognition section 61, an authentication information input section 62, a behavior authority determination section 63, a behavior authority list 64, a behavior authority management section 65, an anomaly behavior judgment section 66, and an output section 67.

The function of each section in the present embodiment is the same as the function of each section as shown in FIG. 1, including the image information input section 10, the behavior recognition section 11, the authentication information input section 12, the behavior authority determination section 13, the behavior authority list 14, the behavior authority management section 15, the anomaly behavior judgment section 16, and the output section 17. However, the behavior recognition section 61 of the present embodiment is different from the behavior recognition section 11 in FIG. 1 in the following point. Namely, the behavior authority information of the person is inputted from the behavior authority management section 65, and based on the behavior authority information, the behavior recognition section 61 recognizes the behavior of the person by focusing on the anomalous behavior of the person.

Further, if the authentication information input section 62 recognizes a person having the highest behavior authority information, or if the highest behavior authority information is inputted to the behavior authority management section 65, the behavior authority management section 65 may output a signal to the behavior recognition section 61, and determine that it is not necessary to recognize the normal and anomalous behaviors of the person. In such a case, no alarm information is created.

Note that instead of outputting a signal to the behavior recognition section 61, a signal may be outputted to the anomaly behavior judgment section 66. In such a case, similarly, the anomaly detection apparatus may determine that it is not necessary to recognize the normal and anomalous behaviors of the person, whereby no alarm information is created.

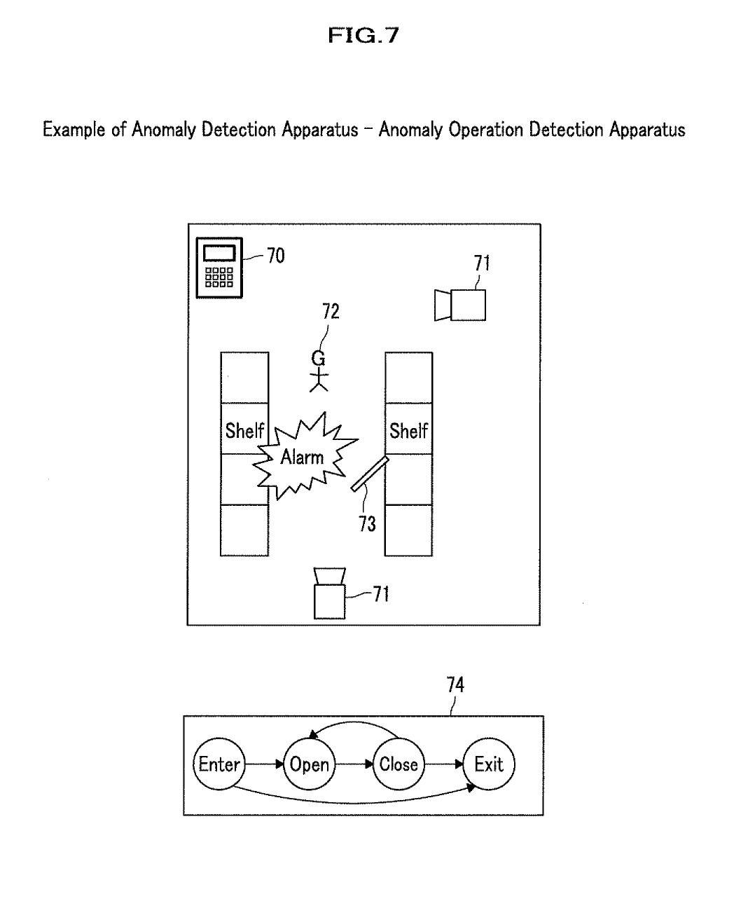

FIG. 7 is a diagram showing an example of an anomaly operation detection apparatus as an embodiment of the anomaly detection apparatus. Here, as shown in FIG. 7, an example will be explained, assuming a case that the anomaly operation detection apparatus cooperates with the authentication device, for example, an entry/exit management device 70 such as an IC card reader and a camera 71. Herein, if an anomaly operation performed by a worker is detected, the anomaly operation detection apparatus creates the alarm information.

For example, a worker 72 is authenticated by a data center and enters a room. A behavior authority list 74 is given to the worker 72.

If a behavior that the worker 72 enters a room occurs, a behavior of opening a door 73 of a shelf housing a server, and a behavior of exiting from the room are normal behaviors, while a behavior of closing the door 73 is anomalous. When a behavior that the worker 72 opens the door 73 occurs, behavior authority criteria deciding normal and anomalous behaviors are modified, whereby a behavior of closing the door 73 becomes a normal behavior, while a behavior of exiting from the room becomes an anomalous behavior. For example, if the worker 72 opens the door 73, a behavior of exiting from the room without closing the door 73 is an anomalous behavior. Accordingly, the anomaly operation detection apparatus creates a warning such as an alarm and issues the alarm.

A sensor or an image processor may detect the behaviors of opening and closing the door 73. Since the behaviors of opening and closing the door 73 make a noise, recognition of the behaviors by the noise may detect whether the behaviors are normal or anomalous. Further, the definition of a behavior to be detected may be added depending on a monitoring purpose.

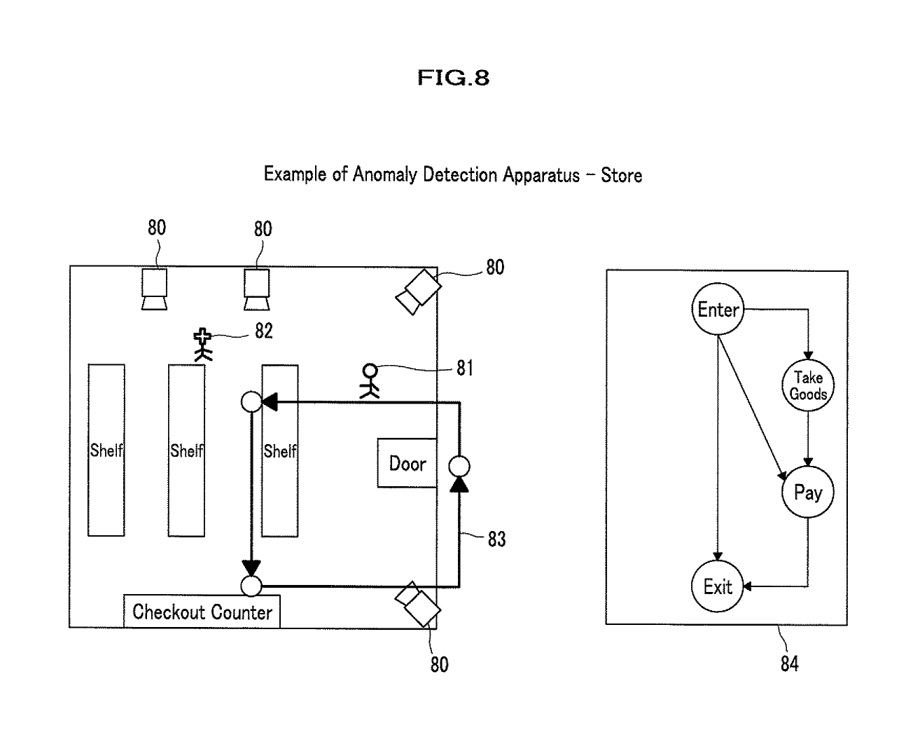

FIG. 8 is a diagram showing an example of an anomaly detection apparatus used for a store in an embodiment of the anomaly detection apparatus. Here, will be explained an example of the anomaly detection apparatus that creates alarm information, if anomalous behaviors of a store manager, a clerk, and a customer are detected by using image information of a camera 80.

For example, if a customer 81 is authenticated by the camera 80, a behavior authority list 84 is given to the customer 81. The behavior authority list 84 defines each behavior including the behaviors of entering a store, taking goods, paying money, and exiting from the store. In such a case, if a customer enters the store, the behaviors of taking goods, exiting from the store, and paying money are all normal behaviors. However, if a behavior of taking goods by a customer occurs, the behavior authority is modified, whereby a behavior of paying money becomes a normal behavior, while a behavior of exiting from the store becomes an anomalous behavior. If a customer takes goods, and directly exits from the store without paying money, the anomaly detection apparatus determines that such a behavior is an anomalous behavior and creates the alarm information. In a usual case, as shown by the route 83, if a customer enters the store, takes good on a shelf, pays money at the checkout counter, and exits from the store, the anomaly detection apparatus determines that the behaviors of the customer are normal and issues no alarm.

Similarly, if the behavior authority information list is given to a clerk, it is possible to determine whether the behavior of the clerk is normal or anomalous. Further, if a store manager 82 is authenticated, the highest behavior authority information is given to the store manager 82. The behavior authority management section 15 determines that it is not necessary to recognize an anomalous behavior corresponding to the highest behavior authority information of the store manager 82. Then, the behavior authority management section 15 transmits a signal to the behavior recognition section 11 or the anomaly behavior judgment section 16 so as not to make the anomalous behavior judgment or not to create the alarm information.

A customer, a clerk and a store manager may be authenticated by using a uniform and a face image or the like recorded by camera images as the authentication information thereof.

According to the present invention, by regarding location information as a behavior, an anomalous behavior of a person may be detected. That is, there are various methods for measuring a location, including, for example, a method by directly measuring a location using a GPS, or a method for measuring a location by using a RFID reader, and performing triangulation of radio wave strength of a RFID. Moreover, by using image information, and converting image data included in the image information into real world coordinates, the location may be determined. Hereinafter, will be explained more specific examples in detail.

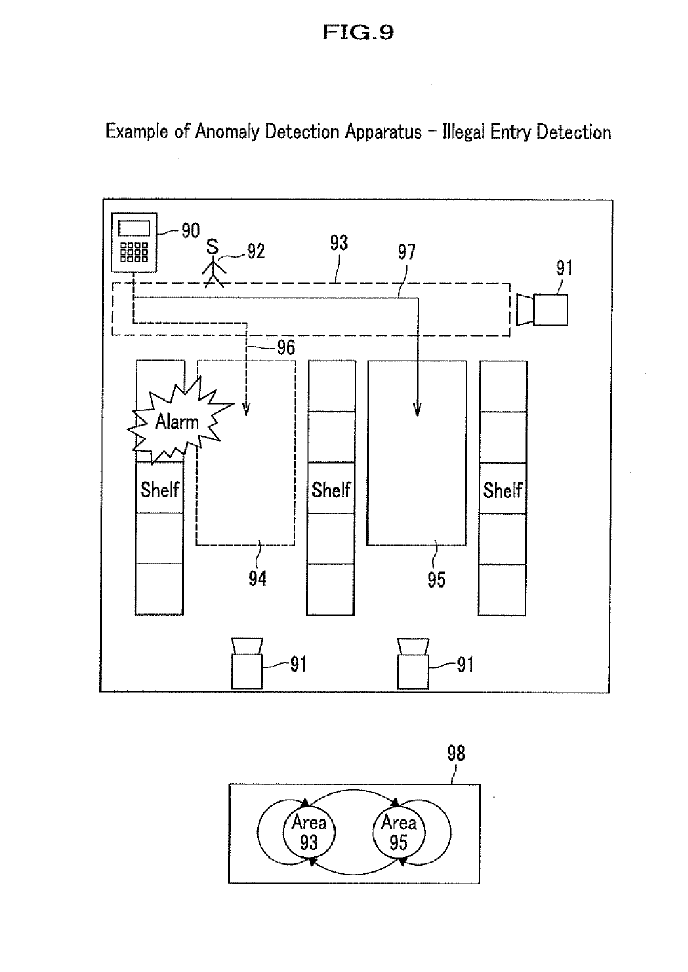

FIG. 9 is a diagram showing an example of an anomaly detection apparatus for detecting an illegal entry in an embodiment of the anomaly detection apparatus of the present invention. Here, as shown in FIG. 9, will be explained an example of the anomaly detection apparatus which cooperates with an entry/exit management device 90 and a camera 91. In the example, if the anomaly detection apparatus detects a person entering a non-permitted area, the anomaly detection apparatus creates alarm information.

For example, assume that a person 92 illegally entering a non-permitted area in a data center is detected. Then, assume that the person 92 is authenticated by the entry/exit management device 90 using, for example, a password, and a behavior authority list 98 is given to the person 92 as shown in FIG. 9. Referring to the behavior authority list 98, it is determined that behaviors of moving from an area 93 to an area 95, moving within the area 93, moving from the area 95 to the area 93, and moving within the area 95 are normal behaviors. As shown by the normal route 97, for the person 92, the behaviors of moving from the area 93 to the area 95 and loitering within the area 95 are within the behavior authority. Accordingly, the anomaly detection apparatus determines that it is not necessary to issue an alarm. In contrast, assume that the person 92 moves from the area 93 to an area 94 as shown by an anomalous route 96, or loitering within the area 94. Since the aforementioned behavior exceeds the behavior authority, the anomaly detection apparatus creates the alarm information.

The anomaly detection apparatus for detecting an illegal entry shown in FIG. 9 may be used for an airport or a factory production line. For example, the anomaly detection apparatus for detecting an illegal entry may detect an anomalous behavior, by determining the behavior authority information on the areas or the like by the authentication information such as an airline ticket and a passport possessed by a customer, and obtaining the location information of the customer by a camera.

Further, according to the present invention, it is possible to simultaneously detect an anomalous behavior and obtain a normal behavior, thereby to guide a person. Hereinafter, more specific examples will be explained in detail.

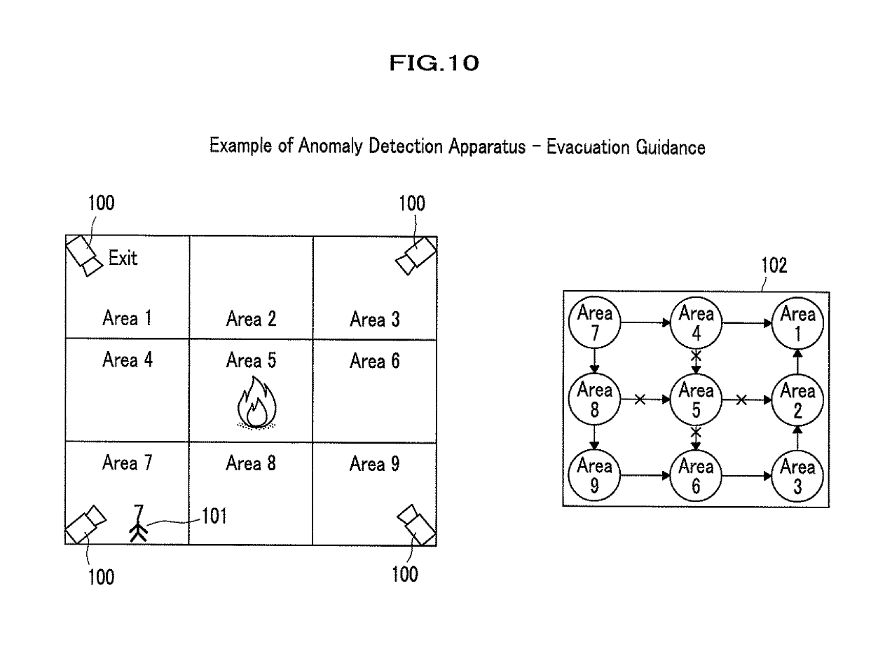

For example, FIG. 10 shows an example of a fire evacuation guiding device in an embodiment of the anomaly detection apparatus. In this example, detail descriptions will be explained, assuming that behavior information is created by regarding location information as a behavior. As shown in FIG. 10, if a fire occurs at an area 5, a person 101 is authenticated by image information taken by a camera 100, and a behavior authority list 102 is created. The fire evacuation guiding device may guide a person 101 to the exit at the area 1 through the area 4 by determining a correct evacuation route, corresponding to the behavior that the person 101 is located at the area 7. More specifically, the behavior of reaching the area 5 is determined as an anomalous behavior. Herein, the behavior of exiting from the area 5 is also determined as an anomalous behavior. Alternatively, if the person 101 selects the area 8, the fire evacuation guiding device may guide the person 101 to the exit at the area 1 by guiding the person 101 to the area 9, and letting the person 101 pass through the area 6, the area 3 and the area 2.

Further, it is possible to output the information on the aforementioned evacuation route. For example, the fire evacuation guiding device may output the announcement of the correct evacuation route to the mobile devices such as a mobile phone and a PDA possessed by the person.

In such a case, a fireman may be recognized as a person having the highest authority by the uniform or the like. Accordingly, the fire evacuation guiding device does not need to recognize the behavior of the fireman, and allows the fireman to enter every area.

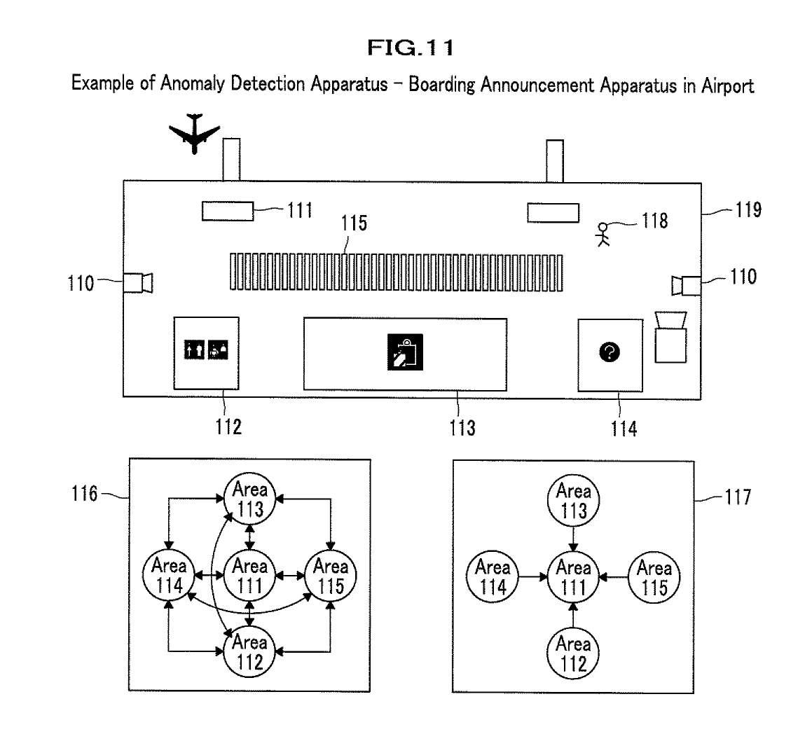

FIG. 11 is a boarding announcement apparatus in an airport as an embodiment of the anomaly detection apparatus. The aforementioned apparatus is designed as the same principle as in FIG. 10. For example, will be explained a case that a person 118 is authenticated by a passport or the like, and subsequently enters a departure lounge 119. According to the airline ticket, the boarding announcement apparatus in the airport obtains the information on the flight number, the departure time and the boarding entrance counter, a behavior authority list 116, and a behavior authority list before the departure 117. As shown in the behavior authority list 116, if there is time to spare by the departure time, the person 118 has the behavior authority of freely moving among the areas of a lavatory area 112, a shopping area 113, an information office area 114, and a moving walk 115. Therefore, no alarm is issued, if the person 118 is moving as mentioned above.

Next, if the departure time of the airplane gets close, the behavior authority list 116 is modified to the behavior authority list before the departure 117.

As shown in the behavior authority list before the departure 117, if the person 118 immediately moves to the boarding entrance counter 111, the boarding announcement apparatus in the airport determines that the behavior is normal, and issues no alarm. However, if the person 118 moves to the areas to which no behavior authority is given, except for the boarding entrance counter 111, the boarding announcement apparatus in the airport determines that the behavior is anomalous, and may create the alarm information. In such a case, the boarding announcement apparatus in the airport may notify the alarm information to a flight crew, allowing the boarding announcement information to be transmitted and highlighted. Further, the boarding announcement apparatus in the airport may send a boarding announcement mail or message to the mobile phone possessed by the person.

Note that the anomalous behavior of the present invention includes a dangerous behavior or a prohibited behavior.

As mentioned above, the present invention has been explained referring to the embodiments. However, the aforementioned construction explained in each embodiment is only an example, and various modifications may be performed without apart from the scope and technical ideas of the present invention. The construction explained in each embodiment may be used in the combination thereof, so long as no contradiction is caused each other.

What is claimed is:

1. An anomaly detection apparatus of detecting an anomalous behavior of a person, by cooperating with an image information input section that outputs a moving image as imaging information through taking a picture of a person by using a camera, and an authentication information input section that outputs authentication information of a person through authenticating the person,
the anomaly detection apparatus comprising:
a behavior recognition section that detects the person included in the moving image resulting from the image information input section, recognizes a behavior of the person, and outputs behavior information of the person by extracting the behavior of the person;
a behavior authority list that defines anomalous and normal behaviors in advance, corresponding to authentication information resulting from the authentication information input section;
a behavior authority determination section that refers to the behavior authority list corresponding to the authentication information of the person, inputted from the authentication information input section, obtains information of anomalous and normal behaviors performed by the person, and outputs a behavior authority information list;
a behavior authority management section that calculates behavior authority of the person corresponding to the behavior of the person, based on the behavior information of the person, inputted from the behavior recognition section, and the behavior authority information list inputted from the behavior authority determination section, and outputs behavior authority information of the person;
an anomaly behavior judgment section that refers to the behavior authority information inputted from the behavior authority management section, determines whether the behavior of the person shown by the behavior information of the person, inputted from the behavior recognition section, is anomalous or not, and outputs alarm information when the behavior is determined as anomalous; and
an output section that issues an alarm when the alarm information is inputted from the anomaly behavior judgment section.

2. The anomaly detection apparatus as described in claim 1, wherein if a person has the highest behavior authority information and is authenticated by the authentication information input section, or if the highest behavior authority information is inputted to the behavior authority management section, the behavior authority management section outputs a signal to the behavior recognition section or the anomaly behavior judgment section, determines that it is not necessary to recognize anomalous and normal behaviors of the person, and creates no alarm information.

3. The anomaly detection apparatus as described in claim 1, wherein
the authentication information input section outputs authentication information of a person by giving the person the lowest behavior authority information, if the authentication information input section is not capable of authenticating the authentication information of the person, and
the behavior authority determination section refers to the behavior authority list by using the authentication information, and outputs the predetermined lowest behavior authority list as a behavior authority information list.

4. The anomaly detection apparatus as described in claim 1, wherein the behavior authority list defines anomalous and normal behaviors corresponding to the authentication information of a person, and comprises data representing the behaviors and the order of the behaviors of the person.

5. The anomaly detection apparatus as described in claim 1, wherein the behavior authority list is modified corresponding to time or a monitoring area.
